(19) United States
(12) Patent Application Publication
(10) Pub. No.: US 2009/0254779 A1
(43) Pub. Date: Oct. 8, 2009

(54) CONTROL APPARATUS

(75) Inventors: Yuusuke Ushio, Tokyo (JP); Takashi Yuguchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Chiyoda-ku, Tokyo (JP)

(21) Appl. No.: 12/306,416

(22) PCT Filed: Mar. 29, 2007
(86) PCT No.: PCT/JP2007/056866

§ 371 Date: Dec. 23, 2008

(30) Foreign Application Priority Data
Jun. 23, 2006 (JP) 2006-174398

(51) Int. Cl. G06F 11/00; G06F 13/00

(52) U.S. Cl. 714/48; 710/300; 714/E11.024

(57) ABSTRACT

A control apparatus performs transmission and reception of data among a plurality of units mounted on a backplane. The control apparatus includes a communication unit that is mounted on the backplane and connected to the units via one-to-one communication lines and relays data among the units by using the communication lines.

### TECHNICAL FIELD

The present invention relates to a control apparatus that performs data communication between units.

### BACKGROUND ART

In recent years, various devices, such as positioning devices and temperature control devices, are performing more complicated operations than before. As a method of controlling such devices, a technique of combining various units, such as sequencers and positioning controllers, is being developed. For example, a technology (a device control system) to control a certain device is available in which arbitrary combination of a plurality of building block type units are connected to a backplane and data is transmitted and received among the units, thereby sharing data thereamong.

In such a device control system, a ladder program is prepared in, for example, a unit serving as a sequencer. According to conditions stated in the ladder program, the sequencer instructs to startup a positioning program that is stored in a positioning controller. The positioning controller performs a positioning process according to, for example, a startup instruction received from the sequencer, and transmits state data to the sequencer.

In a synchronization controller disclosed in Patent Document 1, a plurality of units is connected to a common bus so that those modules (units) can exchange data thereamong in synchronization with each other. Data are exchanged among the units via the common bus, thereby executing user programs.

Patent Document 1: Japanese Patent Application Laid-open No. 2005-293569

### DISCLOSURE OF INVENTION

### Problem to be Solved by the Invention

In the conventional technology, however, the user mounts each unit on a location on the backplane as the user desires. In other words, a predetermined unit is not necessarily mounted on a predetermined slot on the backplane. As a result, electrical properties on the common bus fluctuate depending on the mounting conditions of the units. The mounting conditions can be a mounting location of each unit on the backplane (i.e., a location on which each unit is connected to the common bus) and the number of units mounted on the backplane (i.e., the number of units connected to the common bus). Moreover, in the conventional technology, a plurality of units is connected to the same common bus. Therefore, electrical load on the common bus increases. Thus, in the conventional technology, it is problematic that data transfer speed on the common bus cannot be increased and high speed data transfer cannot be performed among units due to fluctuation of electrical properties on the common bus as well as electrical load on the common bus.

In view bf the foregoing, an object of the present invention is to provide a control apparatus that performs high speed data transfer among units by using a simple structure.

### Means for Solving Problem

To solve the above problems and to achieve the above object, the present invention provides a control apparatus that shares data among a plurality of units mounted on a backplane by transmitting and receiving data among the units. The control apparatus includes a communication unit that is connected to each of the units via one-to-one communication lines mounted on the backplane, and that relays data among the units by using the communications lines.

### Effect of the Invention

In the present invention, the communication unit that relays data among the units is connected to each unit via one-to-one communication lines. Therefore, high speed data transfer over the communication lines and among the units can be achieved effectively by using a simple structure.

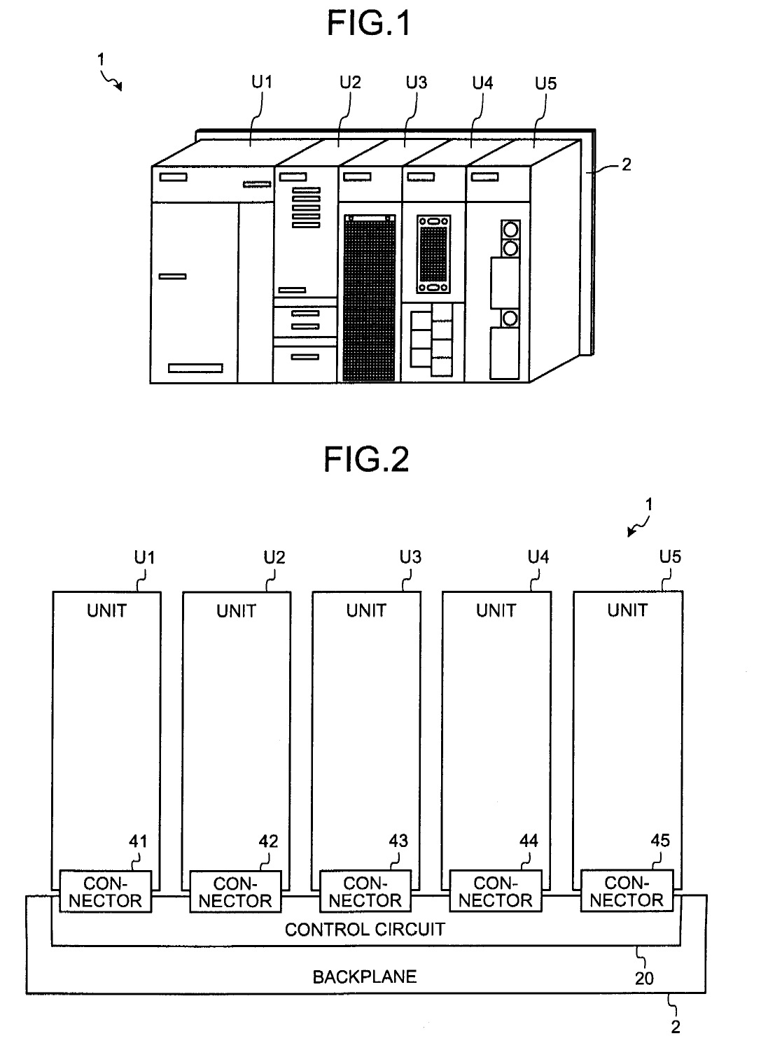

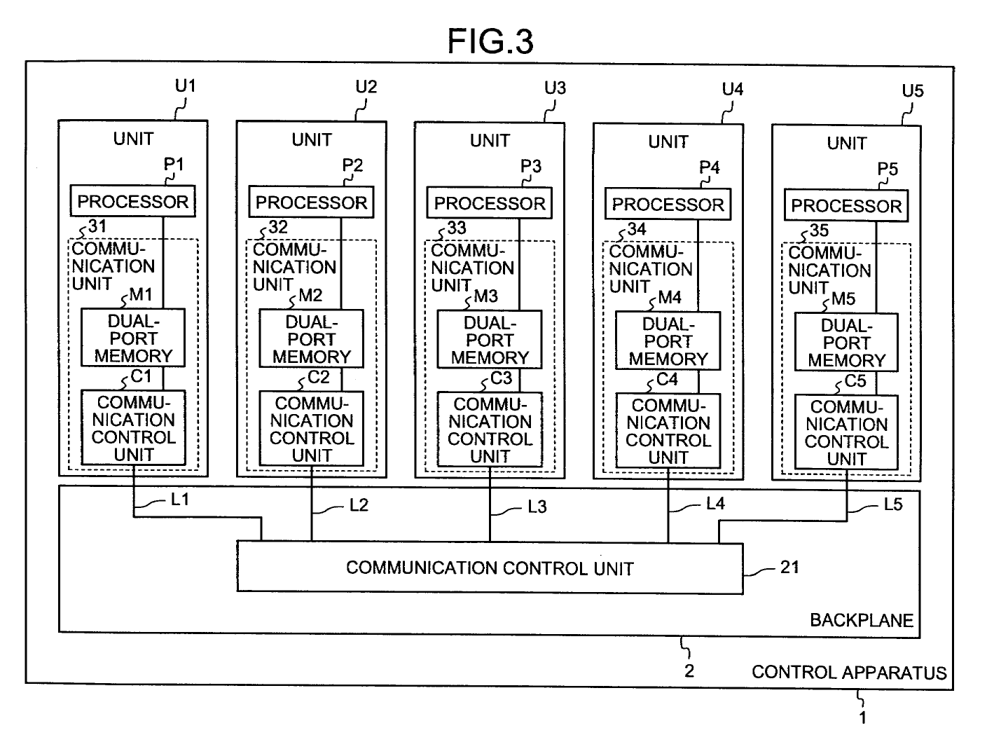

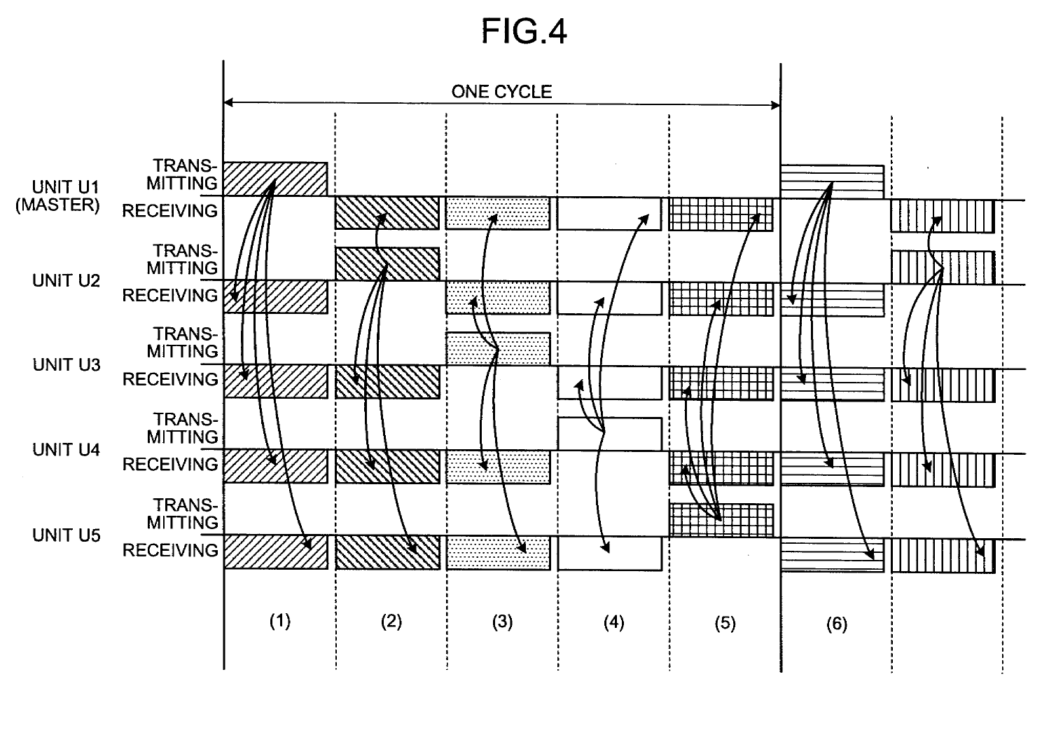

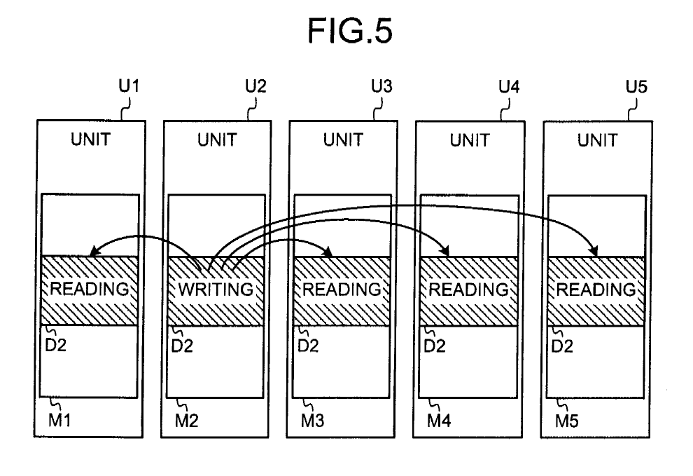

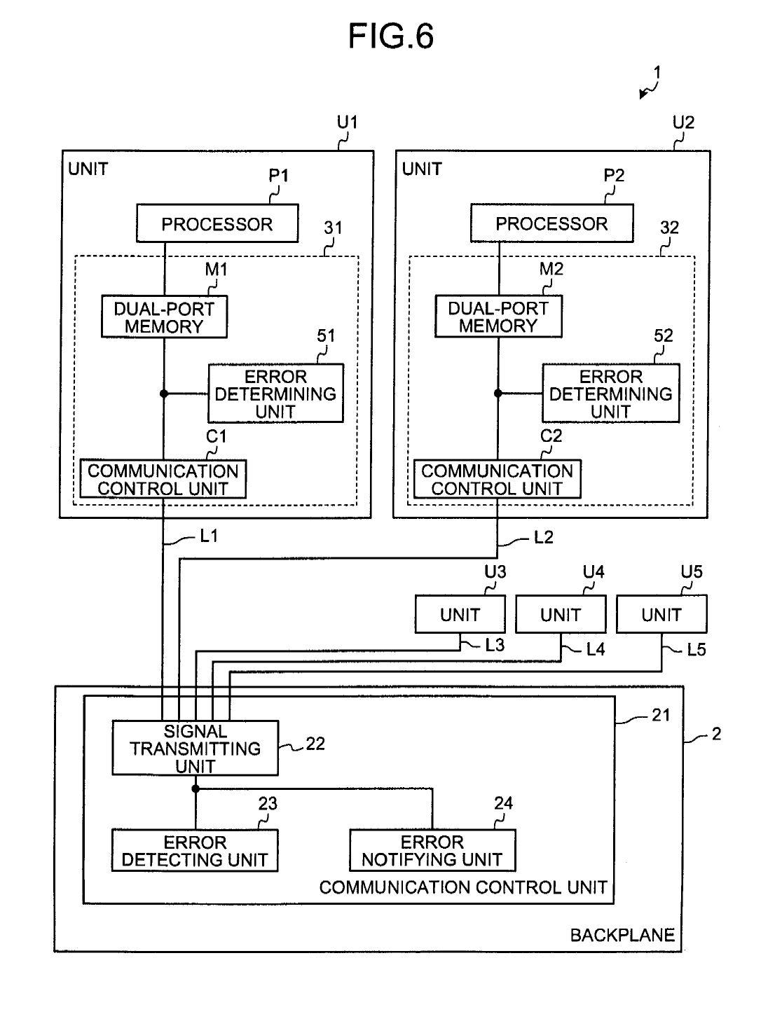

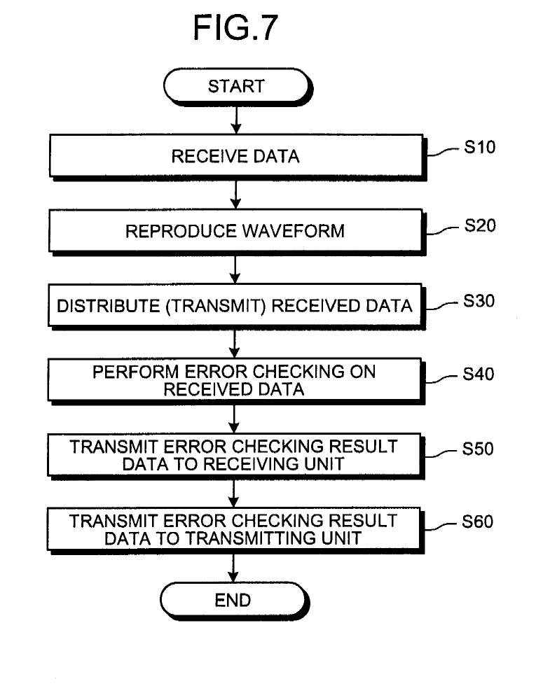

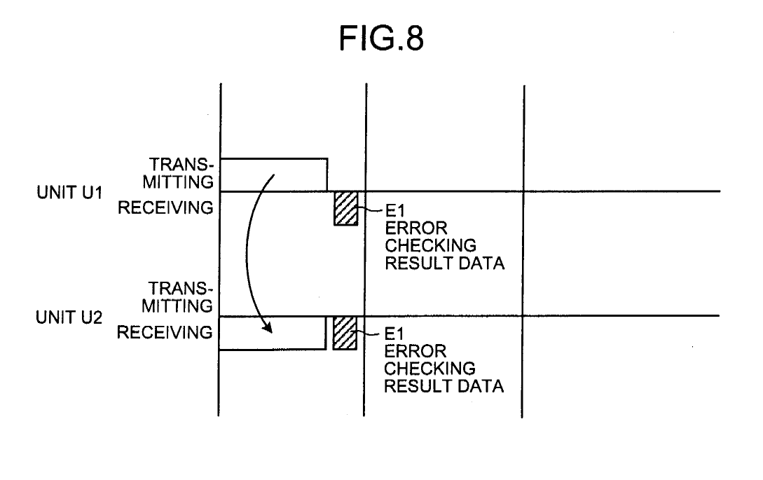

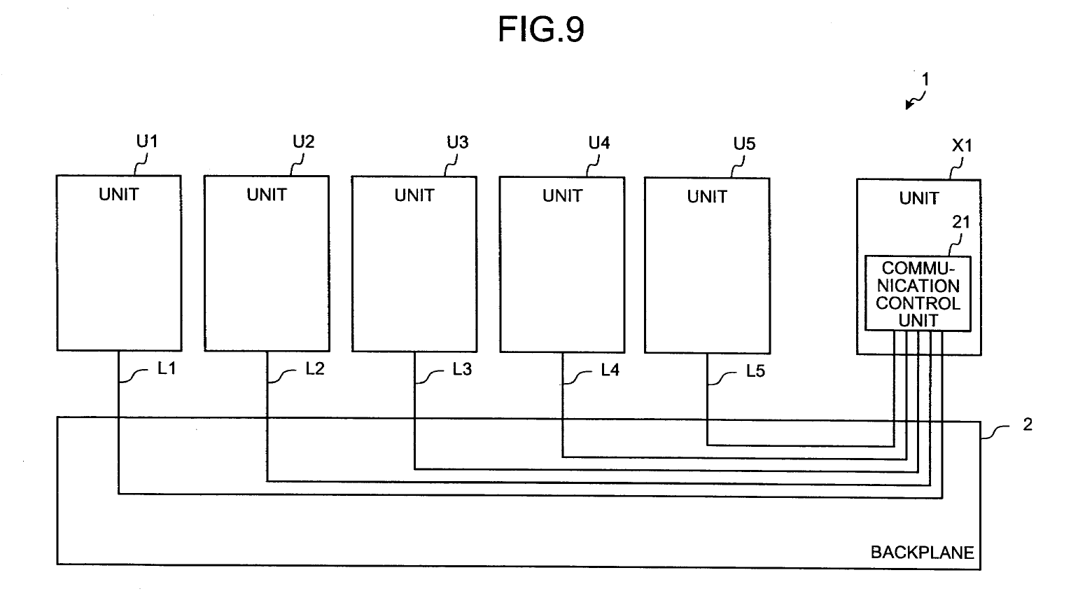

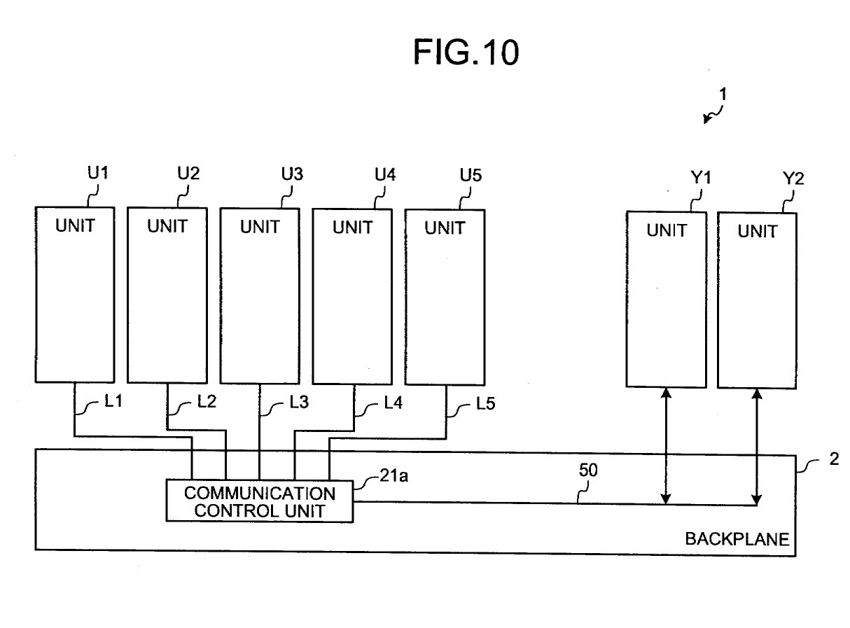

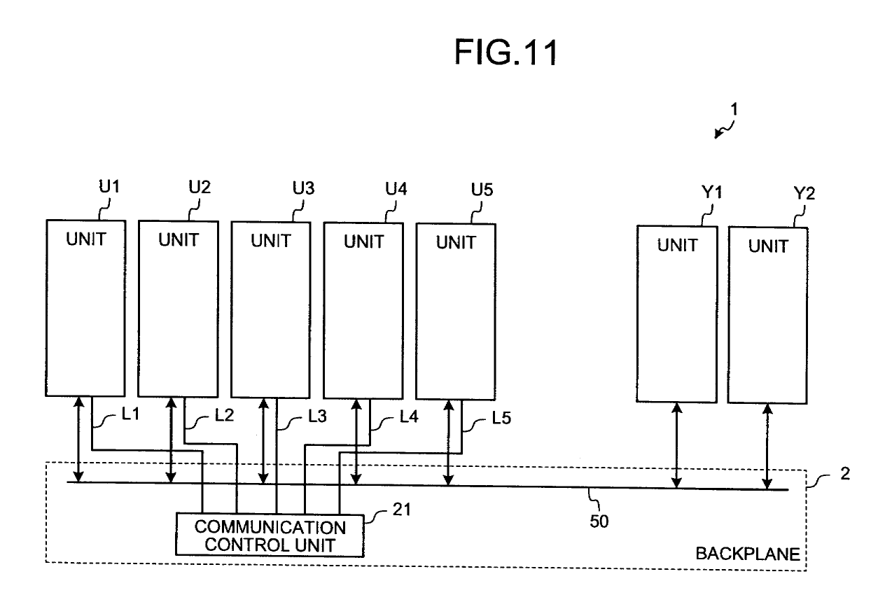

### BRIEF DESCRIPTION OF DRAWINGS

[FIG. 1] FIG. 1 is a perspective view of a control apparatus according to the present invention.

[FIG. 2 ] FIG. 2 is a top view of the control apparatus according to a first embodiment.

[FIG. 3] FIG. 3 is a block diagram of the control apparatus according to the first embodiment.

[FIG. 4] FIG. 4 is a schematic for explaining timing of data transmission and reception among the units.

[FIG. 5] FIG. 5 is a schematic for explaining data transmission and reception process among the units.

[FIG. 6] FIG. 6 is a block diagram of a control apparatus according to a second embodiment.

[FIG. 7] FIG. 7 is a flowchart of operating procedure performed by the control apparatus according to the second embodiment.

[FIG. 8] FIG. 8 is a schematic for explaining timing of transmission and reception of error checking result data.

[FIG. 9] FIG. 9 is a block diagram of a control apparatus according to a third embodiment.

[FIG. 10] FIG. 10 is a block diagram (1) of a control apparatus according to a fourth embodiment.

[FIG. 11] FIG. 11 is a block diagram (2) of the control apparatus according to the fourth embodiment.

### EXPLANATIONS OF LETTERS OR NUMERALS

1 control apparatus
2 backplane
20 control circuit
21, 21a communication control units
22 signal transmitting unit
23 error detecting unit
24 error notifying unit
31 to 35 communication units
41 to 45 connectors
50 common bus
51, 52 error determining units
C1 to C5 communication control units
L1 to L5 communication lines
M1 to M5 dual-port memories
P1 to P5 processors
U1 to U5, X1, Y1, Y2 units

### BEST MODE(S) FOR CARRYING OUT THE INVENTION

Exemplary embodiments of a control apparatus according to the present invention are described below in greater detail with reference to the accompanying drawings. The present invention, however, is not limited thereto.

### First Embodiment

FIG. 1 is a perspective view of a control apparatus according to the present invention. A control apparatus 1 includes a backplane 2 and one or more building block type units. The control apparatus 1 (precisely, the backplane 2) is configured so that one or more units can be detachably mounted thereon. The control apparatus 1 is configured so that, for example, maximum N units can be mounted thereon (where N is a natural number), and actually M units are mounted on arbitrary locations as needed (where M is a natural number equal to or less than N). In the example shown in FIG. 1, the control apparatus 1 has five units, U1 to U5.

The backplane 2 is, for example, plate shaped. The backplane 2 includes a plurality of slots (not shown) on the surface thereof for mounting units. The units are mounted on the slots.

Each of the units U1 to U5 is, for example, rectangular parallelepiped shaped. Each of the units U1 to U5 includes, for example, a control panel, a signal input terminal, and a signal output terminal on the front surface thereof. Moreover, connector pins and the like for connecting a unit to the backplane 2 are provided on the back side of each of the units.

In the control apparatus 1, the units U1 to U5 are mounted on the slots of the backplane 2, and the upper side of the backplane 2 is connected to the backside of each of the units U1 to U5 via connectors and the like.

FIG. 2 is a top view of the control apparatus according to the first embodiment. The backplane 2 includes, for example, a printed circuit board, and a certain circuit, for example, a control circuit 20 is mounted on the printed circuit board. The control circuit 20 includes a circuit that transmits and receives data to and from the units U1 to U5, namely a communication control unit 21 described below. The backplane 2 includes connectors 41 to 45 on its surface for connecting the backplane 2 to each of the units U1 to U5.

The control circuit 20 on the backplane 2 is connected to the units U1 to U5 via the connectors 41 to 45. In FIG. 2, the connectors 41 to 45 are connected to the units U1 to U5 respectively.

FIG. 3 is a block diagram of the control apparatus according to the first embodiment. The control apparatus 1 includes the units U1 to U5 and the backplane 2. The units U1 to U5 are provided with various functions such as a sequencer function, a positioning function, and a temperature control function. Data is transmitted and received to and from the units U1 to U5, thereby sharing data thereamong. Each of the units U1 to U5 is connected to the backplane 2.

The unit U1 includes a processor P1 and a communication unit 31. The unit U2 includes a processor P2 and a communication unit 32. The unit U3 includes a processor P3 and a communication unit 33. The unit U4 includes a processor P4 and a communication unit 34. The unit U5 includes a processor P5 and a communication unit 35.

The communication unit 31 in the unit U1 includes a dual-port memory M1 and a communication control unit C1. The communication unit 32 in the unit U2 includes a dual-port memory M2 and a communication control unit C2. The communication unit 33 in the unit U3 includes a dual-port memory M3 and a communication control unit C3. The communication unit 34 in the unit U4 includes a dual-port memory M4 and a communication control unit C4. The communication unit 35 in the unit U5 includes a dual-port memory M5 and a communication control unit C5.

Each of the units U1 to U5 is described below in greater detail. The units U1 to U5 have similar configuration, so that the unit U1 is described as an example. In the unit U1, the processor P1 is connected to the dual-port memory M1 in the communication unit 31. The dual-port memory M1 is also connected to the communication control unit C1.

The processor (microprocessor) P1 is a means for computing and processing data. The processor P1 controls the unit U1, as well as transmits certain information to the communication unit 31 and an external device (not shown), as needed. The processor P1 reads a computer program stored in a predetermined storage means (not shown), and according to instruction in the read computer program, receives data from, for example, means for storing information such as a memory (for example, the dual-port memory M1). The processor P1 computes and processes the data received from the dual-port memory M1 according to the computer program, and then transmits the data to, for example, the external device.

The dual-port memory M1 is a memory in which data from external sources is input to or output from a single memory cell via two or more internal input/output buses (ports). The dual-port memory M1 includes a port through which the processor P1 can read data from or write data to the dual-port memory M1 and a port through which the communication control unit C1 can read data from or write data to the dual-port memory M1. The dual-port memory M1 stores therein data received from the processor P1 as well as data received from the units U2 to U5 (dual-port memories M2 to M5).

The communication control unit C1 is connected to the communication control unit 21 in the backplane 2 via a communication line L1. The communication control unit C1 controls data communication between the dual-port memory M1 and the backplane 2. The communication control unit C1 transmits the data written to the dual-port memory M1 by the processor P1 to the other units U2 to U5 via the backplane 2, receives from the backplane 2 the data transmitted by the other units U2 to U5 to the backplane 2, and stores the data in the dual-port memory M1.

The communication control unit C1 converts the data (parallel data) read from the dual-port memory M1 into serial data, and transmits the data as a serial signal to the backplane 2. The communication control unit C1 converts the data (serial data) received from the backplane 2 into parallel data, and writes the data in the dual-port memory M1.

In the first embodiment, the communication control units C1 to C5 in the units U1 to U5, respectively, are connected to the communication control unit 21 in the backplane 2 via the one-to-one communication lines L1 to L5. More specifically, the communication control unit 21 in the backplane 2 is connected in a one-to-one manner to the units U1 to U5 mounted on the backplane 2. The one-to-one communication lines L1 to L5 are different from a common bus in that the communication control unit 21 is physically connected to each of the units U1 to U5 in a one-to-one manner via the communication lines L1 to L5 (each of the units U1 to U5 is connected to the communication control unit 21 individually).

The backplane 2 includes the communication control unit (communication unit) 21. When the communication control unit 21 receives data (serial data) from the units U1 to U5, the communication control unit 21 performs waveform regeneration (reshaping) on the received data, and transmits (distributes) the received data to the units other than the unit that transmitted the data. Thus, the communication control unit 21 relays data among the units. When the communication control unit 21 in the backplane 2 receives data from, for example, the unit U1, the communication control unit 21 transmits the data to the units U2 to U5. The connectors that connect the units U1 to U5 to the backplane 2 are not shown in FIG. 3.

Procedure for transmitting and receiving data among the units U1 to U5 in the control apparatus 1 is described below in greater detail. In the control apparatus 1, data are exchanged among the units U1 to U5 at a predetermined cycle. Among the units U1 to U5 in the control apparatus 1, a unit set to be a master unit stores therein information for synchronous communication, namely synchronizing cycle master (synchronous master). A unit that is set to be the master unit and holds synchronous master transmits data to the backplane 2 at the predetermined cycle (timing) according to the synchronous master. The units other than the master unit, however, transmit data to the backplane 2 at the predetermined timing in synchronization with the data transmitted from the master unit.

For example, if the unit U1 is the master unit, for performing one cycle of transmitting and receiving data in the control apparatus 1, the communication control unit C1 first transmits certain data stored in the dual-port memory M1 to the backplane 2 before the other units U2 to U5 transmit data to the backplane 2. In other words, the communication control unit C1 starts one cycle of transmitting and receiving data in the control apparatus 1 before the other units U2 to U5.

If the unit U1 is not the master unit, for performing one cycle of transmitting and receiving data in the control apparatus 1, the communication control unit C1 first receives data from a unit that is set to be the master unit, that is any one of units U2 to U5, via the backplane 2, and then, after elapse of a predetermined time period the communication control unit C1 transmits the data stored in the dual-port memory M1 to the backplane 2. The predetermined time period can be measured either by the processor P1 or by the communication control unit C1.

FIG. 4 is a schematic for explaining timing of data transmission and reception among the units. It is assumed that the unit U1 is set to be the master unit in the control apparatus 1, as well as data transmission is set to be performed in the sequence of the master unit that is the unit U1, the unit U2, the unit U3, the unit U4, and the unit U5. More specifically, in x seconds after data is received from the unit U1, the unit U2 transmits the data to the backplane 2; in (x+t)seconds after the data is received from the unit U1, the unit U3 transmits the data to the backplane 2; in (x+2t) seconds after the data is received from the unit U1, the unit U4 transmits the data to the backplane 2; and in (x+3t) seconds after the data is received from the U1, the unit U5 transmits the data to the backplane 2.

The unit U1 that is set to be the master unit and holds the synchronous master transmits data to the backplane 2 according to the synchronous master. More specifically, the communication control unit C1 transmits to the backplane 2 data written to the dual-port memory M1 by the processor P1. The communication control unit C1 first converts the data written to the dual-port memory M1 into serial data, and transmits the serial data to the backplane 2. The communication control unit C1 transmits the data (serial data) to the backplane 2 via the communication line L1.

The communication control unit 21 in the backplane 2 receives the data transmitted by the unit U1 (the communication control unit U1) to the backplane 2. When the communication control unit 21 receives the data from the unit U1, the communication control unit 21 performs waveform regeneration on the received data and transmits (distributes) the received data to the units U2 to U5 other than the unit U1 that transmitted the data. The data are transmitted from the communication control unit 21 to the units U2 to U5 via the communication lines L2 to L5 respectively. Thus, the units U2 to U5 receive the data transmitted by the unit U1 (1).

On the other hand, in the units U2 to U5, the communication control units C2 to C5 convert data received from the unit U1 into parallel data and store the data in the dual-port memories M2 to M5 respectively. The processors P2 to P5 read the data stored in the dual-port memories M2 to M5, respectively, as needed.

The unit U2, which is configured so as to transmit data after the master unit (the unit U1) completes data transmission, starts transmitting data. In x seconds after the unit U2 completes receiving data from the unit U1, the unit U2 starts transmitting data to the backplane 2. The unit U2 transmits data written to the dual-port memory M1 to the backplane 2, in the manner similar to the process performed by the unit U1, that is, the communication control unit C2 transmits the data written to the dual-port memory M2 by the processor P2 to the backplane 2. The communication control unit C2 converts the data written to the dual-port memory M2 into serial data and transmits the converted data to the backplane 2. The communication control unit C2 transmits the data (serial data) to the backplane 2 via the communication line L2.

The communication control unit 21 in the backplane 2 receives the data transmitted by the unit U2 (the communication control unit C2) to the backplane 2. When the communication control unit 21 receives the data from the unit U2, the communication control unit 21 performs waveform regeneration on the received data and transmits (distributes) the received data to the units U1, U3 to U5 other than the unit U2. The data from the communication control unit 21 to the unit U1, U3 to U5 is transmitted via the communication lines L1, L3 to L5 respectively. Thus, the units U1, U3 to U5 receive the data transmitted by the units U2 (2).

In the units U1, U3 to U5, the communication control units C1, C3 to C5 convert the data received from the unit U2 into parallel data and store the data in the dual-port memories M1, M3 to M5 respectively. The data stored in the dual-port memories M1, M3 to M5 are read by the processors P1, P3 to P5 respectively, as needed.

In (x+t) seconds after the unit U3 completes receiving the data from the unit U1, the unit U3 starts transmitting data to the backplane 2. The data transmitted from the unit U3 to the backplane 2 via the communication line L3 is transmitted to the units U1, U2, U4, and U5 via the communication lines L1, L2, L4, and L5 respectively. Thus, the units U1, U2, U4, and U5 receive the data from the unit 3 (3).

In the units U1, U2, U4, and U5, the communication control units C1, C2, C4, and C5 convert the data from the unit U3 into parallel data and store the data in the dual-port memories M1, M2, M4, and M5 respectively. The data stored in the dual-port memories M1, M2, M4, and M5 are read by the processors P1, P2, P4, and P5 respectively, as needed.

Similarly, in (x+2t) seconds after the unit U4 completes receiving data from the unit U1, the unit U4 starts transmitting the data to the backplane 2. The data transmitted from the unit U4 to the backplane 2 via the communication line L4 is transmitted to the units U1 to U3, U5 via the communication line L1 to L3, L5 respectively. Thus, the units U1 to U3, U5 receive the data from the unit U4 (4).

In the units U1 to U3, U5, the communication control units C1 to C3, C5 convert the data from the unit U4 into parallel data and store the data in the dual-port memories M1 to M3, M5. The data stored in the dual-port memories M1 to M3, M5 are read by the processors P1 to P3, P5 respectively, as needed.

In (x+3t) seconds after the unit U5 receives data from the unit U1, the unit U5 starts transmitting the data to the backplane 2. The data transmitted from the unit U5 to the backplane 2 via the communication line L5 is transmitted to the units U1 to U4 via the communication lines L1 to L4 respectively. Thus, the units U1 to U4 receive the data from the unit U5 (5).

In the units U1 to U4, the communication control units C1 to C4 convert the data from the unit U5 into parallel data and store the data in the dual-port memories M1 to M4. The data stored in the dual-port memories M1 to M4 are read by the processors P1 to P4 respectively, as needed.

Thus, in the control apparatus 1, one cycle of transmitting and receiving data is completed, and the next cycle of transmitting and receiving data is performed. In the next cycle of transmitting and receiving data also, the unit U1 that is set to be the master unit and holds the synchronous master transmits data to the backplane 2 according to the synchronous master, and the units U2 to U5 receive the data from the unit U1 (6). Similarly to the processes (2) to (5), the units U2 to U5 transmit data to the backplane 2 and receive data transmitted by the units other the unit that transmits the data.

An example is explained above in which the unit U1 functions as a master unit. Alternatively, the communication unit 21 can be configured to hold the synchronous master. If the communication control unit 21 holds the synchronous master, the communication control unit 21 transmits information for starting data transmission and reception, namely a starting instruction, to the units U1 to U5. The units U1 to U5 start transmitting data stored therein based on starting instruction.

Because the communication control unit 21 holds the synchronous master, the units U1 to U5 do not have to hold the synchronous master. Therefore, even if a failure occurs in any one of the units U1 to U5, which function as the master unit, data communication can be performed among the units other than the unit having the failure.

An example is explained above in which the units other than the master unit start transmitting data a predetermined time period after receiving data from the master unit. Alternatively, an information table in which the sequence of data transmission is stated can be stored in each of the units other than the master unit, and data can be transmitted according to the information table.

Specifically, the sequence of data transmission is stated in the information table such that the data is transmitted by, for example, the unit U1 (the master unit), the unit U2, the unit U3, the unit U4, and the unit U5 in this order. The unit U2 starts transmitting data stored in the unit U2 after the unit U2 completes receiving data from the unit U1; the unit U3 starts transmitting data stored in the unit U3 after the unit U3 completes receiving data from the unit U2; the unit U4 starts transmitting data stored in the unit U4 after the unit U4 completes receiving data from the unit U3; and the unit U5 starts transmitting data stored in the unit U5 after the unit U5 completes receiving data from the unit U4. The units other than the master unit may start data transmission not according to the information table, in which e and the sequence of data transmission are specified, but according to an instruction from the master unit.

Data transmission and reception process among the units is described below in greater detail. FIG. 5 is a schematic for explaining data transmission and reception process among the units. The data transmitted from the units U1 to U5 are received and stored by the units other than the unit that transmits the data. More specifically, the unit that transmits data writes the data to the units other than the unit that transmits the data, and the units that receive data read the data from the unit other than the units that receive the data.

For example, the unit U2 writes data D2 stored in the dual-port memory M2 in the unit U2 to the other units U1, U3 to U5 (the dual-port memories M1, M3 to M5).

From the viewpoint of the units U1, U3 to U5, however, the units U1, U3 to U5 (the dual-port memories M1, M3 to M5) read the data D2 stored in the dual-port memory M2 in the unit U2.

The data D2 stored in the dual-port memory M2 in the unit U2 is stored each at a certain location (an address) in the dual-port memories M1, M3 to M5 in the units U1, U3 to U5. Thus, data (control data) stored in the units U1 to U5 can be shared by the units U1 to U5.

While according to the first embodiment, the control apparatus 1 includes 5 units, namely, the unit U1 to U5, the control apparatus 1 may include 4 or less units or 6 or more units. The units U1 to U5 and the backplane 2 (the communication control unit 21) may perform error check on the received data.

While in the first embodiment, the units U1 to U5 include the processors P1 to P5 respectively, the units U1 to U5 may be, for example, digital I/O units without a processor. If the units U1 to U5 do not include a processor, the units U1 to U5 each measure when to transmit data by using, for example, timer functions in the communication control units C1 to C5.

Thus, in the first embodiment, the backplane 2 (the communication control unit 21) and the units U1 to U5 are connected by the one-to-one communication lines L1 to L5. Therefore, wiring patterns on the backplane 2 become simple, as well as the number of signal counts in the connectors connecting the backplane 2 to the units U1 to U5 can be reduced.

Because the communication control unit 21 and the units U1 to U5 are connected by the one-to-one communication lines L1 to L5, electrical properties on the communication lines L1 to L5 become stable even if mounting locations of the units U1 to U5 on the backplane 2 or mounting conditions such as the number of units mounted on the backplane 2 are changed. Because the communication control unit 21 and the units U1 to U5 are connected by the one-to-one communication lines L1 to L5, electrical load on the communication lines L1 to L5 can also be reduced. Because the communication control unit 21 and the units U1 to U5 are connected by the one-to-one communication lines L1 to L5, electrical load on the communication control unit 21 can also be reduced. Therefore, data transfer speed on the communication lines L1 to L5 can be increased, and thus high speed data transfer among the units U1 to U5 can be achieved.

### Second Embodiment

A second embodiment of the present invention is described below in greater detail with reference to FIGS. 6 to 8. In the second embodiment, the communication control unit 21 in the backplane 2 performs error check on the data received from units U1 to U5, and notifies error check result to the units U1 to U5.

FIG. 6 is a block diagram of a control apparatus according to the second embodiment. In various elements shown in FIG. 6, similar reference numerals are used to denote elements that achieve functions similar to the control apparatus 1 according to the first embodiment shown. in FIG. 3, and the duplicating descriptions are omitted.

Typically, the unit U1 performs error check on received data. If only the unit U1 includes a function for detecting a receive error, whether an error occurred in a unit that transmitted the data or a unit that received the data cannot be distinguished. In the second embodiment, by adding an error detecting means and an error notifying means on the backplane 2, as well as adding an error determining means on the units that corresponds to the error detecting means and the error notifying means, the location of occurrence of the error can be easily identified. In the control apparatus 1 according to the second embodiment, the communication control unit 21 includes a signal transmitting unit 22, an error detecting unit 23, and an error notifying unit 24. The units U1 to U5 in the control apparatus 1 each include a means for determining communication error in the communication units 31 to 35.

The signal transmitting unit (distributor) 22 performs transmitting process on the data transmitted and received among the units U1 to U5. The error detecting unit 23 is connected to the signal transmitting unit 22, and checks if an error occurs on the data received by the signal transmitting unit 22 from the units U1 to U5 as well as transmits a checking result to the error notifying unit 24. The error detecting unit 23, for example, performs CRC (Cyclic Redundancy Check) check on the data that the signal transmitting unit 22 transmits by using a generator polynomial, and thus detects CRC errors.

The error notifying unit 24 transmits data that denotes the error checking result (error checking result data) (error information) to a unit that transmits data to the signal transmitting unit 22, that is a transmitting unit, or to a unit (a receiving unit) that receives data from the signal transmitting unit 22 according to the error check result that is transmitted by the error detecting unit 23.

The unit U1 includes an error determining unit (error identifying unit) 51 as a means for determining communication error, and the unit U2 includes an error determining unit 52 as a means for determining communication error. Error determining units provided in the units U3 to U5 are not shown in FIG. 6.

The error determining units 51 and 52 determine if an error occurs on the transmitted or received data and identify the location of occurrence of the error, according to the error checking result data transmitted by the error notifying unit 24 in the communication control unit 21 or data received from the other units and the backplane 2.

Operating procedure for the control apparatus according to the second embodiment is described below in greater detail. FIG. 7 is a flowchart of operating procedure of the control apparatus according to the second embodiment. As an example of operating procedure of the control apparatus 1, procedure in which data stored in the unit U1 is transmitted to the units U2 to U5 is described. Descriptions about the processes performed in the control apparatus 1 similar to the control apparatus according to the first embodiment are omitted.

The unit U1 transmits the data stored in the dual-port memory M1 to the communication control unit 21 in the backplane 2 at a predetermined timing. The signal transmitting unit 22 in the communication control unit 21 receives the data from the unit U1 via the communication line L1 (Step S10). The signal transmitting unit 22 reproduces a signal waveform of the received data, and distributes (transmits) the signal waveform to the units U2 to U5 (Steps S20 and S30).

The signal transmitting unit 22 transmits the data received from the unit U1 to the error detecting unit 23. The error detecting unit 23 performs error checking on the data (received data) input by the signal transmitting unit 22 (Step S40).

The error detecting unit 23 notifies an error checking result of the received data to the error notifying unit 24. The error detecting unit 23 checks, for example, if a CRC error occurs therein. After the signal transmitting unit 22 transmits data from the unit U1 to the unit U2, the error detecting unit 23 performs error check on the data. This is because the error detecting unit 23 receives all the data, and performs CRC check thereon. The signal transmitting unit 22 transmits the data, which is received from the unit U1, to the unit U2 as it is. Therefore, it is not that the signal transmitting unit 22 completes receiving all the data from the unit U1 and then transmits the received data to the unit U2, but that the signal transmitting unit 22 receives data and sequentially transmits the data to the unit U2.

The error notifying unit 24 transmits the error checking result data to the unit U1 (transmitting unit) that transmits data to the signal transmitting unit 22 and to the units U2 to U5 (receiving units) to which the signal transmitting unit 22 transmits the received data, according to the error checking result notified by the error detecting unit 23 (Steps S50 and S60).

The error notifying unit 24 may first transmit the error checking result data either to the unit U1 that is the transmitting unit or to the units U2 to U5 that are the receiving units. The error notifying unit 24 may also transmit the error checking result data simultaneously to the unit U1 that transmits the data and to the units U2 to U5 that receive the data. The error notifying unit 24 may also transmit the error checking result data to any one of the unit U1 that transmits the data and the units U2 to U5 that receives the data.

Thus, the location of occurrence of the error is identified in the units U1 to U5. Then, any one of the units U2 to U5 starts transmitting data, starting at the second data transmission in a cycle, and the error detecting unit 23 performs error check on the data after the second data transmission.

FIG. 8 is a schematic for explaining timing of transmission and reception of the error checking result data. In the example shown in FIG. 8, the error notifying unit 24 transmits the error checking result data simultaneously to the unit U1 that transmits data and to the unit U2 that receives data.

When data is transmitted by the unit U1, the communication control unit 21 (the signal transmitting unit 22) in the backplane 2 transmits the data from the unit U1 to the unit U2. Thus, the unit U2 receives the data from the unit U1. Then, the error notifying unit 24 transmits an error checking result data E1 to the unit U1 and the unit U2. Thus, the unit U1 and the unit U2 receive. the error checking result data E1.

If an error occurs in the data that is transmitted by the unit U1 via the backplane 2, the unit U2 that receives data cannot determine if the error occurred in the unit U1 that transmits the data or in the unit U2 that receives the data.

Therefore, the error determining unit 52 in the unit U2 first performs, for example, CRC error check on the data transmitted by the unit U1. When the error determining unit 52 in the unit U2 detects an error in the data transmitted by the unit U1, the error determining unit 52 checks the error checking result data E1 transmitted by the communication control unit 21.

The error determining unit 52 determines that the error in the data is due to the unit U1 that transmits the data, if an error occurs in the data transmitted by the unit U1 and if an error is indicated in the error checking result data E1 transmitted by the communication control unit 21.

If an error occurs in the data transmitted by the unit U1, and in the error checking result data E1 no error is indicated, the error determining unit 52 determines that the error is due to the unit U2 that receives data.

In the unit U1 that transmits data, after the unit U1 transmits data therefrom and before the other units start transmitting data, the unit U1 receives the error checking result data E1 from the error notifying unit 24. Therefore, the error determining unit 51 determines that an error occurred somewhere between the unit U1 and the backplane 2, if it is indicated that an error occurs in the error checking result data E.

Above, it is assumed that a receive error does not occur in the error checking result data E1. By combining information of a receive error of data transmitted from the unit U1 to the unit U2, the content of the error checking result data E1 received from the backplane 2, and information of a receive error of the error checking result data E1, however, the error determining units 51 and 52 can determine what the error is due to. For example, if the error determining unit 52 detects a receive error in the data transmitted from the unit U1 to the unit U2, it is indicated that an error occurs in the content of the error checking result data E1 received from the backplane 2, and a receive error of the error checking result data E1 is not detected, then it is determined that the error does not occur somewhere between the backplane 2 and the unit U2 but between the unit U1 to the backplane 2. If the error determining unit 52 detects a receive error of the data transmitted from the unit U1 to the unit U2, and a receive error of the error checking result data E1 is detected, then it is determined that the error occurred somewhere between the backplane 2 and the unit U2, no matter what the content of the error checking result data E1 is.

The unit U1 can identify the location of occurrence of the error by combining the data transmitted by the unit U1 and the error checking result data E1 transmitted by the backplane 2. For example, if in the content of the error checking result data E1 received by the unit U1 it is indicated that an error occurs as described above, and a receive error of the error checking result data E1 is note detected, then it is determined that the error occurred during transmitting data from the unit U1 to the backplane 2. If a receive error of the error checking result data E1 is detected, it is determined that the error occurred during receiving data from the backplane 2 to the unit U1, no matter what the content of the error checking result data E1 received by the unit U1 is.

If the error determining unit 51 in the unit U1 determines that an error occurs in the data transmitted by the unit U1, the error determining unit 51 notifies the user that an error occurs in the transmitted data by using a means for displaying information such as an LED (Light Emitting Diode) (not shown) that the unit U1 includes.

In the second embodiment, after the signal transmitting unit 22 transmits data from the unit U1 to the unit U2, the error detecting unit 23 performs error check on the data. Alternatively, if the error detecting unit 23 can transmit data while performing error check on the received data, the error detecting unit 23 may perform error check and transmit data simultaneously.

In the second embodiment, the unit U1 that transmits data determines that an error occurs in the data that is transmitted by the unit U1 if in the error checking result data E1 it is indicated that an error occurs. Alternatively, the unit U1 that transmits data may determine that an error occurs in the data transmitted by the unit U1 if the unit U1 does not receive any error checking result data from the error notifying unit 24 in a predetermined time period after the unit U1 completes transmitting data.

In the second embodiment, the error notifying unit 24 transmits all the error checking result data to the unit U1 that transmits data no matter what the content of the error checking result is. Alternatively, the error notifying unit 24 may transmit the error checking result data, in which it is indicated that an error occurs, to the unit U1 that transmits data only if an error occurs in data. Then, the unit U1 that transmits data determines that no error occurs in the data transmitted by the unit U1 if the unit U1 does not receive any error checking result data from the error notifying unit 24 in a predetermined time period after the unit U1 completes transmitting data.

Thus, according the second embodiment, because the unit U1 that transmits data and the unit U2 that receives data each receive error checking result data from the communication control unit 21 (the error notifying unit 24), the location of occurrence of the error (an error spot) can be easily identified.

### Third Embodiment

A third embodiment of the present invention is described below in greater detail with reference to FIG. 9. According to the third embodiment, a certain unit, not the backplane 2, includes the communication control unit 21. The communication control unit 21 in the unit is connected to the units U1 to U5 via one-to-one communication lines L1 to L5.

FIG. 9 is a block diagram of a control apparatus according to the third embodiment. In various elements shown in FIG. 9, similar reference numerals are used to denote elements that achieve functions similar to the control apparatus 1 according to the first embodiment shown in FIG. 3, and the duplicating descriptions are omitted.

The control apparatus 1 according to third embodiment includes the units U1 to U5, a unit X1, and the backplane 2. The unit X1 includes the communication control unit 21. The communication control unit 21 is connected to the units U1 to U5 via the communication lines L1 to L5. Operations performed by the control apparatus 1 are similar to the control apparatus 1 according to the first embodiment. Therefore, the descriptions thereof are omitted.

In the present embodiment, the unit X1 that includes the communication control unit 21 is different from the units U1 to U5, however, any one of the units U1 to U5 may include the communication control unit 21.

Thus, in the third embodiment, the unit X1 in the control apparatus 1 includes the communication control unit 21. Therefore, the backplane 2 can have a simple structure. As a result, by using the backplane 2 having a simple structure, high speed data transfer among the units U1 to U5 can be performed.

### Fourth Embodiment

A fourth embodiment of the present invention is described below in greater detail with reference to FIG. 10. In the fourth embodiment, a communication control unit 21a is connected to units U1 to U5 via one-to-one communication lines L1 to L5, as well as to other units Y1 and Y2 via a common bus.

FIG. 10 is a block diagram of a control apparatus according to the fourth embodiment. In various elements shown in FIG. 10, similar reference numerals are used to denote elements that achieve functions similar to the control apparatus 1 according to the first embodiment shown in FIG. 3, and the duplicating descriptions are omitted.

The control apparatus 1 according to the fourth embodiment includes units U1 to U5, units Y1 and Y2, and the backplane 2. The units Y1 and Y2 are units, such as an I/O unit, that can hold only a small amount of data. Amount of data that can be stored in the units Y1 and Y2 is smaller than that can be stored in the units U1 to U5. Moreover, data stored in the units Y1 and Y2 are data that can be transmitted at a transfer speed lower than the transfer speed among the units U1 to U5.

The communication control unit 21a in the control apparatus 1 is connected in a one-to-one manner to the units U1 to U5 mounted on the backplane 2 via the communication lines L1 to L5. The communication control unit 21a in the control apparatus 1 is also connected to the units Y1 and Y2 mounted on the backplane 2 via a common bus 50.

In the control apparatus 1, data is transmitted between the units Y1 and Y2, as well as data is transmitted among the units U1 to U5 at a transfer speed higher than a transfer speed between the units Y1 and Y2. The communication control unit 21a includes a function that converts (switches) between the data transfer using the communication lines L1 to L5 and the data transfer using the common bus 50, and thus data can be transmitted between the units U1 to U5 and the units Y1 and Y2. Thus, conventional data transfer via the common bus 50 can be performed as well as high speed data transfer can also be performed.

The control apparatus 1 may be configured in the following manner. That is, the communication control unit 21 can be connected to the units U1 to U5 via the one-to-one communication line L1 to L5, as well as the communication control unit 21 can be connected to the units U1 to U5, Y1, and Y2 via the common bus 50. FIG. 11 is a block diagram of another control apparatus according to the fourth embodiment. In various elements shown in FIG. 11, similar reference numerals are used to denote elements that achieve functions similar to the control apparatus 1 according to the first embodiment shown in FIG. 3, and the duplicating descriptions are omitted.

The control apparatus 1 includes unit U1 to U5, units Y1 and Y2, and the backplane 2. The communication control unit 21 in the control apparatus 1 is connected in a one-to-one, manner to the units U1 to U5 mounted on the backplane 2 via the communication lines L1 to L5, respectively. The units U1 to U5 are also connected to each other via the common bus 50. The units U1 to U5 performs data transfer via the communication lines L1 to L5, and the units U1 to U5, the units Y1, and Y2 perform data transfer via the common bus 50. Thus, conventional data transfer via the common bus 50 as well as a high speed data transfer can be performed.

Thus, according to the fourth embodiment, conventional data transfer using the units Y1, Y2, and the common bus 50, as well as high speed data transfer via the one-to-one communication lines L1 to L5 can be performed.

### INDUSTRIAL APPLICABILITY

Thus, the control apparatus according to the present invention is appropriate for data transfer among units.

1.-10. (canceled)

11. A control apparatus that performs transmission and reception of data among a plurality of units mounted on a backplane, the control apparatus comprising a communication unit that is mounted on the backplane and connected to each of the units via one-to-one communication lines mounted on the backplane, and that relays data among the units by using the communications lines.

12. The control apparatus according to claim 11, wherein the communication unit comprises:
an error detecting unit that detects an error in data received from a unit from among the units according to the data; and
an error notifying unit that transmits an error detection result detected by the error detecting unit to a unit from among the units as error information.

13. The control apparatus according to claim 12, wherein the error notifying unit transmits the error information to a unit that receives the data.

14. The control apparatus according to claim 12, wherein the error notifying unit transmits the error information to the unit that transmitted the data.

15. The control apparatus according to claim 12, wherein the unit that receives the error information from the error notifying unit includes an error identifying unit that identifies a location of occurrence of the error in the data by using the error information.

16. The control apparatus according to claim 15, wherein the error identifying unit identifies, when the unit in question is a unit that receives data, the location of occurrence of the error in the data according to data that is transmitted by the unit that transmits the data via the communication unit and the error information transmitted by the error notifying unit.

17. The control apparatus according to claim 11, further comprising an additional unit other than the units connected to the communication unit via the one-to-one communication lines, wherein the communication unit is connected to the additional unit via a common bus that is mounted on the backplane.

18. The control apparatus according to claim 11, wherein the units connected to the communication unit via the one-to-one communication lines are also connected via a common bus that is mounted on the backplane.
